(19) United States
(12) Patent Application Publication
(10) Pub. No.: US 2023/0292768 A1
(43) Pub. Date: Sep. 21, 2023

(54) BAKING COVER

(71) Applicants: Michael W. Taylor, Williamstown, MA (US); Warren Taylor, Williamstown, MA (US)

(72) Inventors: Michael W. Taylor, Williamstown, MA (US); Warren Taylor, Williamstown, MA (US)

(21) Appl. No.: 18/123,393

(22) Filed: Mar. 20, 2023

Related U.S. Application Data
(60) Provisional application No. 63/321,428, filed on Mar. 18, 2022.

(51) Int. Cl. A21B 3/13; A47J 37/01; A47J 36/06; A47J 45/06; A47J 36/02; A21D 8/06

(52) U.S. Cl. CPC A21B 3/135; A47J 37/01; A47J 36/06; A47J 45/063; A47J 36/02; A21D 8/06

(57) ABSTRACT

A baking cover including a body section having an interior surface and an exterior surface opposite the interior surface, the body section including a rim formed at the confluence of the interior surface and the exterior surface, the rim configured to demountably couple with a surface; the body section forming a baking volume configured to receive a bread dough.

### CROSS REFERENCE TO RELATED APPLICATION

This application claims the benefit of provisional application Ser. No. 63/321,428, filed Mar. 18, 2022.

### BACKGROUND

The present disclosure is directed to the improved bread baking cover.

Home bread bakers use a variety of techniques to achieve results similar to professional kitchens. They lack the specialized equipment—such as high temperature steam injection ovens—used to produce bread with a thin crunchy crust and also a light airy interior (crumb).

To create bread with these characteristics, the temperature and humidity surrounding the baking bread dough must be controlled at several stages. In the initial stage of baking, the raw dough should be subjected to a very hot environment with high humidity. The interior of the dough heats quickly resulting in an increase in volume (oven spring) due to several processes that increase pressure within cavities in the dough. This increase in pressure can only result in expansion of the dough if the exterior of the dough (which is exposed to the highest heat) remains supple and flexible.

If the exterior environment is humid, water vapor will condense on the cooler dough and then evaporate and heating continues. The phase change of liquid water to vapor reduces the surface temperature delaying the hardening of the exterior surface and allowing the dough to expand. Crust formation is enhanced by the external moisture as starches are dissolved and transformed into brittle compounds as they heat.

In later stages of baking, humidity should be decreased to increase the crust temperature, caramelizing sugars and driving the Maillard process which involves a chemical reaction between amino acids and reducing sugars that gives browned food its distinctive flavor that results in browning. Traditionally, home bakers have utilized one of two techniques to create these conditions.

Humidity is added to the entire oven by pouring water (or ice cubes) into a hot pan or skillet placed on the bottom of the oven. This results in a burst of steam and the oven door is quickly shut. Downsides of this technique including danger of scalding the baker with hot steam and the high humidity in the entire oven can lead to rusting of metal.

Another technique utilized in the art can include preheating a heavy walled vessel 1 as seen in FIG. 1, typically of cast iron. The bread dough is placed in the heavy walled vessel 1—first covered to maintain internal humidity and then uncovered. The humidity is created from water evaporating from the wet bread dough. This technique essentially is creating a secondary small volume oven inside the main oven 2.

While the cast iron cooking vessel 1 has proven to create good results, difficulties with use of the cast iron cooking vessel 1 include the long pre-heating time required (60-90 minutes), difficulty and danger of moving the heavy heated vessel in and out of the oven 2 and around the kitchen (not shown). Typical weight of cast iron vessels is up to 22 lbs./10 kg. that must be pre-heated to 500F/260C. Certain configurations require the use of a sling (not shown) constructed of parchment paper to lower the dough in the vessel so it can be placed gently without burning hands.

What is needed is a low thermal mass baking cover with a high thermal conductivity and high infrared absorptivity and emissivity that covers the bread dough on any flat surface, such as a cooking sheet or baking stone.

### SUMMARY

In accordance with the present disclosure, there is provided a baking cover comprising a body section having an interior surface and an exterior surface opposite the interior surface, the body section including a rim formed at the confluence of the interior surface and the exterior surface, the rim configured to demountably couple with a surface; the body section forming a baking volume configured to receive a bread dough.

A further embodiment of any of the foregoing embodiments may additionally and/or alternatively include the baking volume can be configured to be an enclosed volume responsive to the rim demountably coupling with the surface.

A further embodiment of any of the foregoing embodiments may additionally and/or alternatively include the baking cover further comprising a handle coupled to the body section proximate the exterior surface.

A further embodiment of any of the foregoing embodiments may additionally and/or alternatively include the handle is configured as thermally non-conductive.

A further embodiment of any of the foregoing embodiments may additionally and/or alternatively include the handle is positioned on the exterior and configured to allow a baker to hold the cover in a location that allows for placement of the cover over the bread dough without pulling out the surface.

A further embodiment of any of the foregoing embodiments may additionally and/or alternatively include the baking cover further comprising a first end wall and a second end wall opposite the first end wall formed in the body section.

A further embodiment of any of the foregoing embodiments may additionally and/or alternatively include the baking cover further comprising a first side wall and a second side wall opposite the first side wall formed in the body section.

A further embodiment of any of the foregoing embodiments may additionally and/or alternatively include the body section comprises a low thermal mass material with a high thermal conductivity and high infrared absorptivity and emissivity.

A further embodiment of any of the foregoing embodiments may additionally and/or alternatively include the body section is comprises an aluminum alloy formed into a shape to accommodate the bread dough.

A further embodiment of any of the foregoing embodiments may additionally and/or alternatively include at least one of the interior surface and the exterior surface is treated to achieve IR absorptivity and emissivity as close to 1 as possible, to approximate a blackbody.

In accordance with the present disclosure, there is provided a process for baking a bread dough utilizing a baking cover, the process comprising placing a dough on a surface responsive to the oven obtaining a predetermined temperature; covering the dough with the baking cover, the baking cover comprising a body section having an interior surface and an exterior surface opposite the interior surface, the body section including a rim formed at the confluence of the interior surface and the exterior surface, the rim configured to demountably couple with the surface; the body section forming a baking volume configured to receive the dough; forming an enclosed volume between the baking cover and the surface; trapping humid air around the dough; maintaining the humid air next to the dough; removing the baking cover after the dough is fully expanded, and the surface temperature of the dough has reached a temperature that has driven off the moisture at the surface of the dough; and baking the dough in the absence of the baking cover

A further embodiment of any of the foregoing embodiments may additionally and/or alternatively include the surface is selected from the group consisting of a flat surface within an oven, a baking stone, baking steel and baking/cookie sheet configured to be placed within the oven.

A further embodiment of any of the foregoing embodiments may additionally and/or alternatively include the process further comprising a handle coupled to the body section proximate the exterior surface; wherein the handle is configured as thermally non-conductive.

A further embodiment of any of the foregoing embodiments may additionally and/or alternatively include the process further comprising positioning the handle on the exterior and configuring the handle to allow a baker to hold the cover in a location that allows for placement of the cover over the bread dough without pulling out the surface from an oven.

A further embodiment of any of the foregoing embodiments may additionally and/or alternatively include the body section comprises a low thermal mass material with a high thermal conductivity and high infrared absorptivity and emissivity.

A further embodiment of any of the foregoing embodiments may additionally and/or alternatively include the body section is comprises an aluminum alloy formed into a shape to accommodate the bread dough.

A further embodiment of any of the foregoing embodiments may additionally and/or alternatively include at least one of the interior surface and the exterior surface is treated to achieve IR absorptivity and emissivity as close to 1 as possible, to approximate a blackbody.

Other details of the baking cover are set forth in the following detailed description and the accompanying drawings wherein like reference numerals depict like elements.

### BRIEF DESCRIPTION OF THE DRAWINGS

FIG. 1 is an image of a prior art heavy walled vessel utilized for bread making.

FIG. 2 is an image of an exemplary baking cover.

FIG. 3 is a top isometric view schematic representation of the exemplary baking cover.

FIG. 4 is a bottom isometric view schematic representation of the exemplary baking cover.

FIG. 5a is an isometric view of the exemplary baking cover.

FIG. 5b is an end view of the exemplary baking cover.

FIG. 5c is a side view of the exemplary baking cover.

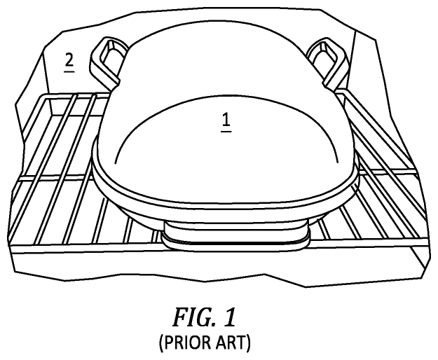

### DETAILED DESCRIPTION

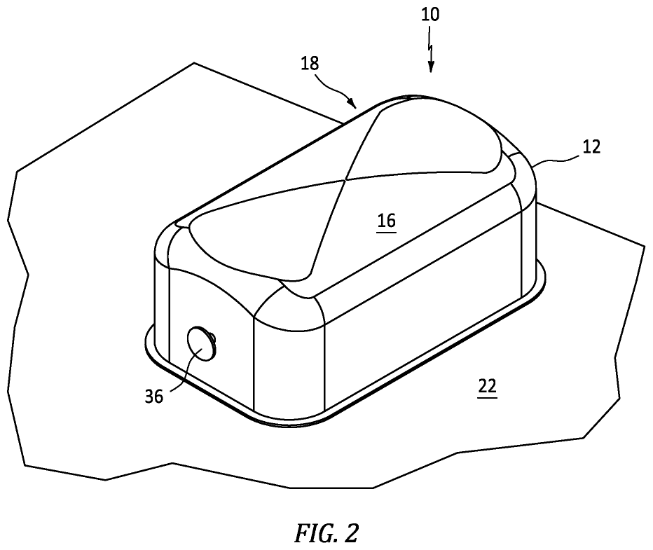

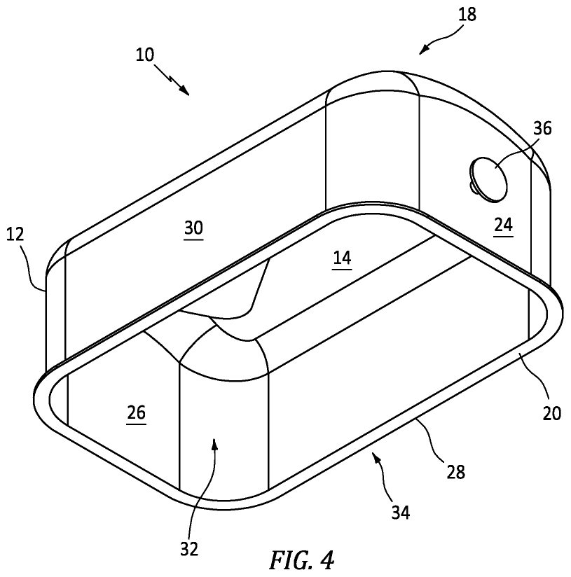

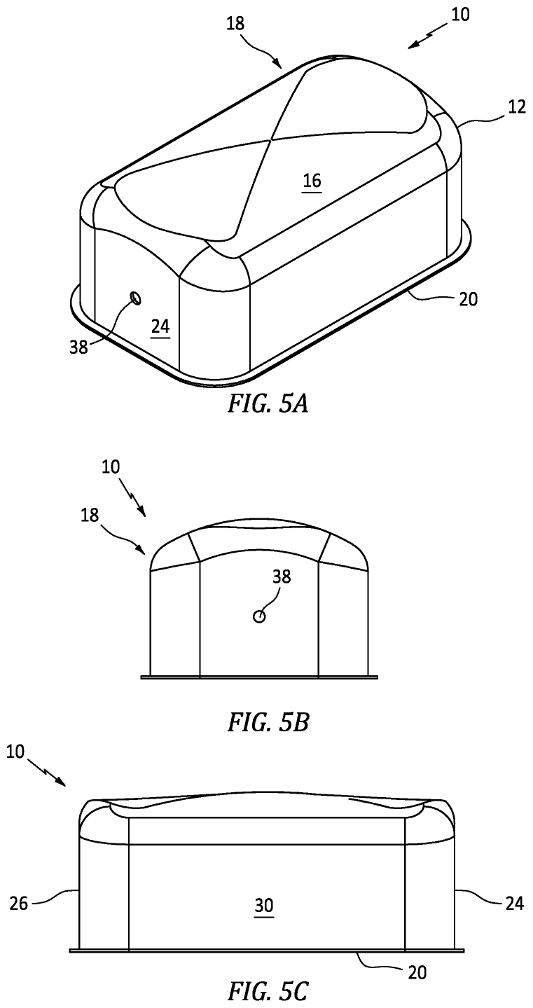

Referring now to FIGS. 2-4 and 5a-5c, there is illustrated an exemplary baking cover 10. The baking cover 10 includes a body section 12 having an interior surface 14 (FIG. 4) and an exterior surface 16 opposite the interior surface 14. The body section 12 can be formed as a dome shape 18. In exemplary embodiments, in order to maximize IR radiation on the surface of the dough 40, the shape can approximate the shape of a loaf, so that the interior surface 14 to dough 40 distance is minimized. It is contemplated that other shapes to follow the contours of other popular loaves can be incorporated. For example; a dome that the round (when viewed from the top) to follow the contour of the traditional round boule loaf; a long rectilinear shape (use crosswise in a home oven) for baking baguettes, shaped long and thin; and the like. The body section 12 includes a rim 20 at the intersection of the interior surface 14 and exterior surface 16. The rim 20 is configured to contact a surface 22. The surface 22 can be a baking sheet, baking stone, oven surface and the like.

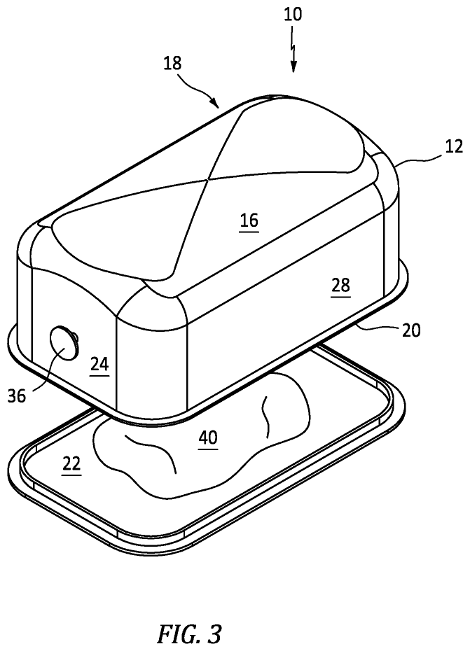

The body section 12 can include end walls 24, 26 located at opposite ends of the body section 12. The body section 12 can include side walls 28, 30 opposite each other and approximately orthogonal to the end walls 24, 26. In the exemplary embodiment shown in the figures, the body section 12 is formed as a rectilinear shape, in other embodiments elliptical, oval and other non-rectilinear shapes can be envisioned. The dome shape 18 can enclose a baking volume 32 proximate the interior surface 14. The baking volume 32 can become an enclosed volume 34 when the rim 20 is contacted with the surface 22. The enclosed volume 34 can contain the bread dough 40 (shown at FIG. 3).

In an exemplary embodiment, the body section 12 can be constructed from a low thermal mass material with a high thermal conductivity and high infrared absorptivity and emissivity. Low thermal mass is technically specific heat×mass. The engineering requirement is to minimize thermal mass (reduce the energy required to heat the making cover to oven temperature), maximize absorptivity (absorbs IR radiation to heat quickly) and maximize thermal conductivity (the cover heat from thermal conduction as heat flows from hot air into the material, AND importantly heat flows from the external surface that is absorbing IR to the internal surface where IR is emitted. Both inside and outside of the cover will be heated by conduction of heat from the air, but IR heating of the external surface dominates the overall heating.

An example can include the following: Energy required to heat from room temp to 500F (260C) typical baking temperature. Temperature differential from room temp to baking temp 20C—260C that is 240C (or 240K difference);

Cast Iron
10 kg. vessel
Specific heat Cp=0.46 kJ/kg K
10 kg×0.46 kJ/kg K×240K=1104 kJ

Aluminum
0.18 kg cover
Specific heat Cp=0.91 kJ/kg K
0.18 kg×0.91 kJ/kg K×240K=40 kJ
Thermal conductivity (room temperature)
Cast iron: 52 W/m-K
Aluminum alloy: 170 W/m-K
Emissivity (which equals absorptivity)
Aluminum bare: <0.1
Anodized aluminum: >0.90 (typical)

Note: Cast iron is typically “seasoned” black and similar in emissivity to anodized aluminum

The construction can be from an aluminum alloy formed into a shape to accommodate the bread dough 40. The body section 12 can be thin, for example, less than 1 mm in thickness, such as 0.5 mm thickness aluminum to minimize thermal mass and remain lightweight to handle. The interior surface 14 and/or exterior surface 16 can be treated to achieve IR absorptivity and emissivity as close to 1 as possible, to approximate a blackbody. Such surface treatments can include anodization which is excellent—temperature resistant, very non-reactive, and emissivity >0.90. A paint or powder coat is possible. The surface treatment can be anything that makes the surface dark and that will increase emissivity.

A handle 36 can be attached to the body section 12. In an exemplary embodiment, the handle 36 can be located proximate the end walls 24, 26. A receiver 38 can be formed in the end walls 24, 26 to enable the attachment of the handle 36. The handle 36 can be constructed from thermally nonconductive materials that remain relatively cool compared to the body section 12 as well as shaped to minimize becoming overheated for ease of use. The handle 36 can be located to allow a baker to hold the cover 10 in a location that allows for placement of the cover 10 over the bread dough 40 without pulling out the surface 22, for example an oven shelf, thus minimizing the time an oven door must be open allowing the thermal energy to escape from the oven. The handle 36 and cover 10 design provides the technical advantage of maintaining oven temperature and decreases the time to recover full temperature (typically 500F/260C) within the oven.

A process of using the baking cover 10 can include the first step of placing a raw dough 40 on the surface 22, for example, any type of a flat surface within the oven including a baking stone, baking steel or thin baking/cookie sheet. In the case of heavier stones or steels these are pre-heated in the oven but require no more pre-heating time than the oven itself. In exemplary embodiments with the use of heavier stones or steels that are pre-heated in the oven might increase oven preheat by 20-30%. Once the oven is at temperature, the raw dough 40 is transferred onto the flat surface 22 using one of several techniques. The lightweight cover 10 is then placed over the dough 40. As the dough 40 heats and releases water vapor, the cover 10 traps humid air around the dough 40 in the enclosed volume 34.

Due to the high absorptivity and low thermal mass of the cover 10, the cover 10 will heat quickly from room temperature (in an exemplary embodiment in less than 90 seconds). Alternatively, the cover 10 can be preheated prior to placing the bread dough 40 in the oven, although this is not required. As the cover 10 heats, due to the high emissivity, IR radiation emitted from the interior surface 14 of the cover 10 towards the bread dough 40. Within several minutes, from a thermodynamic and radiative IR aspect, it is as if the cover 10 does not exist. However, the cover 10 does enclose the enclosed volume 34 environment around the bread dough 40 and maintains the humidity of the air next to the dough 40. After the dough 40 is fully expanded, the surface temperature of the dough 40 has reached a temperature that has driven off the majority of the moisture, the cover 10 is removed using the handle 36. The bread dough 40 continues to bake in a drier environment until done.

A technical advantage of the disclosed baking cover includes achieving all the same aspects of the prior art cast iron vessel techniques.

There has been provided a baking cover. While the baking cover has been described in the context of specific embodiments thereof, other unforeseen alternatives, modifications, and variations may become apparent to those skilled in the art having read the foregoing description. Accordingly, it is intended to embrace those alternatives, modifications, and variations which fall within the broad scope of the appended claims.

What is claimed is:

1. A baking cover comprising:
a body section having an interior surface and an exterior surface opposite the interior surface, the body section including a rim formed at the confluence of the interior surface and the exterior surface, said rim configured to demountably couple with a surface; said body section forming a baking volume configured to receive a bread dough.

2. The baking cover according to claim 1, wherein said baking volume can be configured to be an enclosed volume responsive to said rim demountably coupling with said surface.

3. The baking cover according to claim 1, further comprising:
a handle coupled to said body section proximate said exterior surface.

4. The baking cover according to claim 3, wherein said handle is configured as thermally non-conductive.

5. The baking cover according to claim 3, wherein said handle is positioned on said exterior and configured to allow a baker to hold the cover in a location that allows for placement of the cover over the bread dough without pulling out the surface.

6. The baking cover according to claim 1, further comprising:
a first end wall and a second end wall opposite said first end wall formed in said body section.

7. The baking cover according to claim 1, further comprising:
a first side wall and a second side wall opposite said first side wall formed in said body section.

8. The baking cover according to claim 1 wherein the body section comprises a low thermal mass material with a high thermal conductivity and high infrared absorptivity and emissivity.

9. The baking cover according to claim 1, wherein said body section is comprises an aluminum alloy formed into a shape to accommodate the bread dough.

10. The baking cover according to claim 1, wherein at least one of said interior surface and said exterior surface is treated to achieve IR absorptivity and emissivity as close to 1 as possible, to approximate a blackbody.

11. A process for baking a bread dough utilizing a baking cover, the process comprising:
placing a dough on a surface responsive to the oven obtaining a predetermined temperature;
covering said dough with the baking cover, said baking cover comprising a body section having an interior surface and an exterior surface opposite the interior surface, the body section including a rim formed at the confluence of the interior surface and the exterior surface, said rim configured to demountably couple with the surface; said body section forming a baking volume configured to receive the dough;
forming an enclosed volume between said baking cover and said surface;
trapping humid air around the dough;
maintaining the humid air next to the dough;
removing the baking cover after the dough is fully expanded, and the surface temperature of the dough has reached a temperature that has driven off the moisture at the surface of the dough; and
baking the dough in the absence of the baking cover.

12. The process of claim 11, wherein said surface is selected from the group consisting of a flat surface within an oven, a baking stone, baking steel and baking/cookie sheet configured to be placed within said oven.

13. The process of claim 11, further comprising:
a handle coupled to said body section proximate said exterior surface; wherein said handle is configured as thermally non-conductive.

14. The process of claim 11, further comprising:
positioning said handle on said exterior and configuring said handle to allow a baker to hold the cover in a location that allows for placement of the cover over the bread dough without pulling out the surface from an oven.

15. The process of claim 11, wherein the body section comprises a low thermal mass material with a high thermal conductivity and high infrared absorptivity and emissivity.

16. The process of claim 11, wherein said body section is comprises an aluminum alloy formed into a shape to accommodate the bread dough.

17. The process of claim 11, wherein at least one of said interior surface and said exterior surface is treated to achieve IR absorptivity and emissivity as close to 1 as possible, to approximate a blackbody.
